(19) United States
(12) Patent Application Publication
(10) Pub. No.: US 2010/0282088 A1
(43) Pub. Date: Nov. 11, 2010

(54) DEVICE FOR BREWING A BEVERAGE

(75) Inventors: Louis Deuber, Richterswil (CH); Andreas Luzzi, Schmerikon (CH); Erwin Brändle, Benken (CH); Heiner Prechtl, Rapperswil (CH); Marco Pfister, Eschenbach (CH); Claudio Foscan, Rapperswil (CH)

Correspondence Address: THE NATH LAW GROUP, 112 South West Street, Alexandria, VA, 22314, US

(73) Assignee: DELICA AG, BIRSFELDEN (CH)

(21) Appl. No.: 12/733,261

(22) PCT Filed: Jul. 24, 2008
(86) PCT No.: PCT/EP2008/059707

§ 371 Date: Jul. 8, 2010

(30) Foreign Application Priority Data
Aug. 22, 2007 (EP) 0714778.9

(51) Int. Cl. A47J 31/58; A47J 31/44; A47J 31/00

(52) U.S. Cl. 99/281; 99/295; 99/288; 99/285

(57) ABSTRACT

A device for brewing a beverage, such as for example a coffee machine, has a brewing chamber for receiving a substance to be brewed or a portion pack containing this substance. The device is also provided with an electric pump for passing liquid through the brewing chamber and with a heat-insulated electric flow heater for heating up the liquid. After a predeterminable time following the end of a brewing operation or following the actuation of an operating element has elapsed, the device can be switched over by an electrical switching module into a very energy-efficient standby mode, in which at least the flow heater, and preferably also other loads, do not consume any electrical energy and are turned off.

The invention relates to an apparatus for brewing a beverage. By way of example, this may be a coffee machine or else a machine for brewing alternative drinks, such as tea, cocoa or soup.

Apparatuses of this kind are today used in many private households but also in offices, common rooms etc., where they are not operated continuously but only in particular intervals of time. In the meantime, the apparatuses operate in a ready mode, which requires a considerable amount of electrical power, however. Particularly in the case of coffee machines, the power consumption in ready mode is high because a particular relatively high water temperature needs to be maintained constantly.

By way of example, WO 97/24052 has disclosed a coffee machine which, according to the object on which the invention is based, is not meant to require any preheating time and is not meant to consume any power in the ready state. To this end, a continuous-flow heater with a low heat capacity is used instead of a solid electrical heating block. To obtain the desired water output temperature, a control loop is used. In this case, the continuous-flow heater comprises a pipe which comprises a plurality of layers and which contains a wound heating wire. This continuous-flow heater is intended to be used to attain high temperatures quickly. Furthermore, a control loop is provided, the control variable of which is the water temperature at the end of the continuous-flow heater.

These measures are not yet able to reduce the power consumption satisfactorily, however. In particular, all the main loads are not yet completely isolated from the power supply system. It is therefore an object of the invention to provide an apparatus of the type cited at the outset which requires the smallest possible supply of power for the largest possible degree of readiness and in which particularly all the main loads are completely isolated from the power supply in the quiescent phase. In this case, the apparatus is nevertheless intended to be very easy to use and to have a high level of operational reliability. Furthermore, the apparatus is intended to be simple to manufacture and maintain. The invention achieves this object by means of an apparatus which has the features in claim 1.

The use of the electronic switching module not only reduces the power consumption in ready mode but also allows an approximately zero-power standby mode to be attained, apart from a minimal control current. This relates particularly to the continuous-flow heater, which in this way is not only regulated but also completely switched off or isolated from the power supply system. Preferably, the pump may also be connected in the same way, so that it is not possible to operate the pump within the standby mode.

Particularly advantageously, not only the continuous-flow heater but also further electrical loads such as sensors, lighting means and the like are included in the standby mode, said loads being able to have their power consumption reduced or being able to be switched off, that is to say being able to be completely isolated from the power supply system, by said standby mode. Particularly temperature sensors, flow sensors, light-emitting diodes on switches, digital indicators and much more consume electrical power even when the apparatus is not needed. The inclusion of said loads in the standby mode allows the power consumption to be reduced further.

Particular ease of use is achieved if the apparatus has a plurality of lighting means, particularly for indicating a state, which are able to be switched off by the switching module with the exception of a single lighting means which is used for indicating the standby mode. In this way, it is possible to tell that the apparatus has actually been activated, although on the basis of the last use it is necessary to accept a shorter or longer period before a ready state is restored.

In this case, the standby mode can advantageously be terminated by operating a control element of the apparatus, wherein it is either possible to actuate a ready mode in which the continuous-flow heater is heated or else to restart a brewing operation directly. The latter applies when the temperature on the continuous-flow heater is still at such a level that it does not require any heating time. The standby mode can be interrupted by operating a start key, for example. Provided that it is ready, the apparatus then immediately begins a brewing operation or uses appropriate lighting means to indicate that it is not yet ready.

The power consumption in standby mode is advantageously reduced to no more than 0.5 watt, preferably to no more than 0.3 watt. Such a low standby power consumption is obviously of no consequence even over a relatively long period of time.

It has been found, surprisingly, that optimum operating values can be attained if the continuous-flow heater is provided with heat-insulating external insulation, the heat transfer coefficient of which is no more than 2 W/m²K, preferably no more than 1 to 1.5 W/m²K. The effect achieved with such optimum heat-insulating values is that even after a relatively long quiescent phase the ready status is maintained, or is reached again within seconds. In this case, the continuous-flow heater may be designed such that it can be used to achieve temperatures of at least 95° C. relatively quickly, for example with a heating power of 1000 watts even from cold start within just around one minute. The heat-insulating external insulation may be chosen such that, by way of example, the cooling from the ready state in standby mode after 2 hours is no more than 40° C., preferably no more than 50° C. With such a shallow cooling curve, only very short waiting times or no waiting times at all need to be accepted following interruption of the standby mode.

The external insulation advantageously comprises a heat-resistant, dimensionally stable and easily shapeable plastic material. In this case, a copolymer of propene and olefins (Expanded Polypropylene—EPP) has been found to be particularly suitable. This material is also known under the trademark Neopolen®, for example. It is used in vehicle construction and in the packing industry, for example, including for parts which are subject to high mechanical loads.

The continuous-flow heater may have different designs. A cuboid design has been found to be particularly advantageous, with the continuous-flow heater being able to have a meandrous passage channel. The cuboid shape is relatively compact and facilitates embedding into external insulation to the fullest extent possible. The external insulation is advantageously designed such that it encompasses the continuous-flow heater with a largely precise fit. In this case, it is conceivable for the external insulation to be formed by two interlocking half-shells which preferably have a precise fit and which are held together with or without additional clamping means. Since the continuous-flow heater needs to be accessible for maintenance purposes, the two half-shells with a precise fit can easily be opened and securely closed again. Examples of suitable clamping means which may be considered are screws, spring clamps, strapping belts or the like. As an alternative, it would naturally also be conceivable for the external insulation to be entirely or partially permanently connected to the continuous-flow heater, however.

The switching module may have been programmed by means of a timer such that the standby mode occurs on a user-selectable basis, with the standby mode being able to be switched on after 30 seconds to 120 seconds, for example, preferably after approximately 60 seconds since a brewing operation was terminated or since a control element was last operated. The optimum insulation on the continuous-flow heater allows such extremely short switch-off times. Depending on how intensively an apparatus is used, these switch-off times could possibly even be extended or shortened.

A further advantage can be achieved by virtue of the brewing chamber being intended to hold a capsule, wherein the capsule can be penetrated when the brewing chamber is closed, and an opening element being provided for the purpose of opening and closing the brewing chamber or for the purpose of ejecting the capsule, wherein the operation of the opening element interrupts the standby mode. Just opening or closing the brewing chamber therefore interrupts the standby mode, so that the apparatus would immediately be ready for a rinsing operation with water even if the brewing chamber were totally empty, for example.

Particularly advantageously, the apparatus has a programmable control circuit which can be used to program operation-related parameters or which can be used to store operation-related parameters for diagnostic purposes. By way of example, this control circuit also contains the timer which initiates the standby mode. However, this control circuit can also be used to actuate various other parameters, it being possible to store a diagnostic program which allows particular actual parameters to be requested.

The design of the brewing apparatus is based on the aspects of overall optimization in terms of use, operation, maintenance and repair. The highest possible flexibility is ensured by virtue of all possible operation-related adjustments for the use of various brewing materials, for example, or the process optimization being able to be implemented exclusively by means of software adjustments. Service work on the apparatus is simplified by means of complete diagnostics via the control circuit.

The control circuit used may particularly advantageously be a microprocessor of the ATmega8™ type from Atmel Corporation, 2325 Orchard Parkway, San Jose, Calif. 95131, USA, for example. This multifunctional microprocessor (RISC processor) can be described by the following properties:
8-bit RISC architecture,
integrated nonvolatile memory for the program code (FLASH),
integrated nonvolatile memory for parameters (IIPROM),
various interfaces (SPI/I2C/USART/GPIO),
timer,
analog/digital converter,
safety functions (watchdog, brown-out detector),
integrated clock generation (few external components required).

The microprocessor also works as a digital tool. By way of example, it is thus possible to read the number of coffees (including the type of coffee or alternatively tea), the operative software and hardware versions (basic settings) and some error messages. This is done via the debug and configuration interface using a special connecting cable and a standard PC.

An optimum arrangement of the continuous-flow heater in the housing of the apparatus can be attained by virtue of the continuous-flow heater being supported and/or mounted on the external insulation within the apparatus in order to avoid heat bridges. In this way, only poorly conductive plastic tubes are routed to or away from the continuous-flow heater, without metal connecting elements such as screws, pins, clips or the like being conductively connected to the body of the continuous-flow heater, for example.

Further advantages and individual features of the invention can be found in the exemplary embodiment described below and in the drawings, in which:

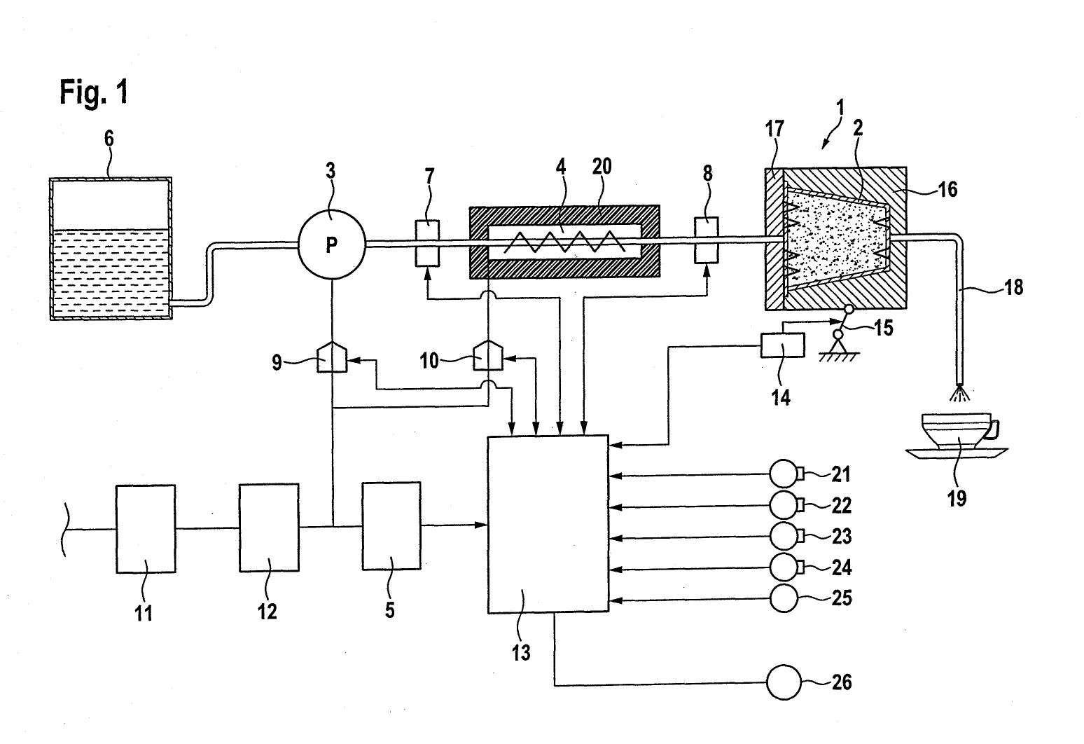

FIG. 1 shows a schematic illustration of a coffee machine having the features of the invention,

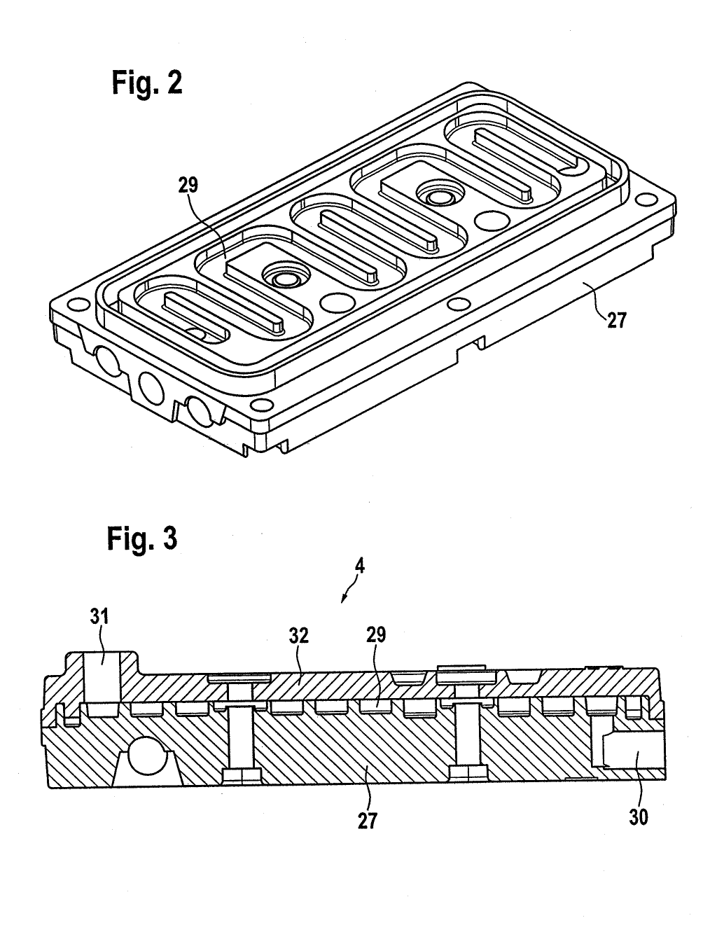

FIG. 2 shows the perspective illustration of a basic element for a continuous-flow heater,

FIG. 3 shows a longitudinal section through a continuous-flow heater having the basic element shown in FIG. 2,

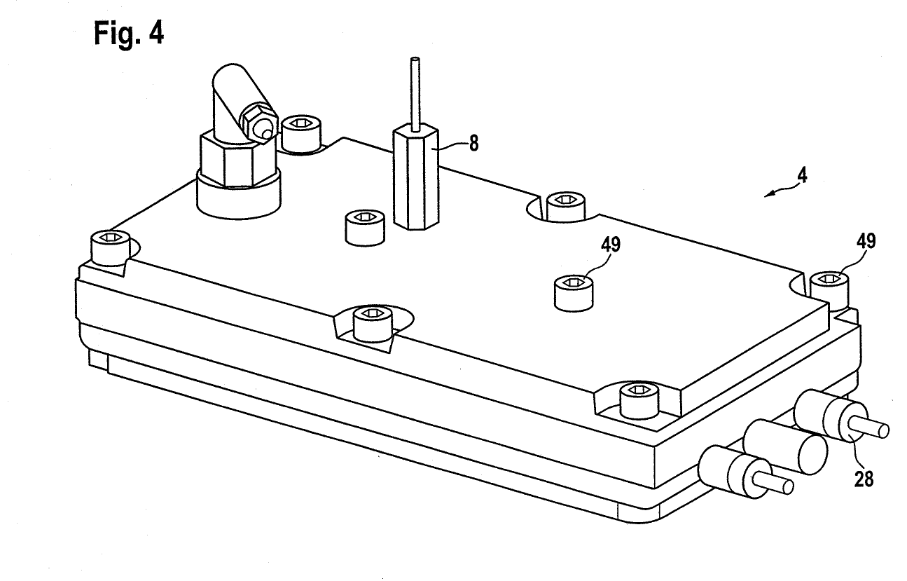

FIG. 4 shows a perspective illustration of the continuous-flow heater shown in FIG. 3 with connection elements and a mounting plate,

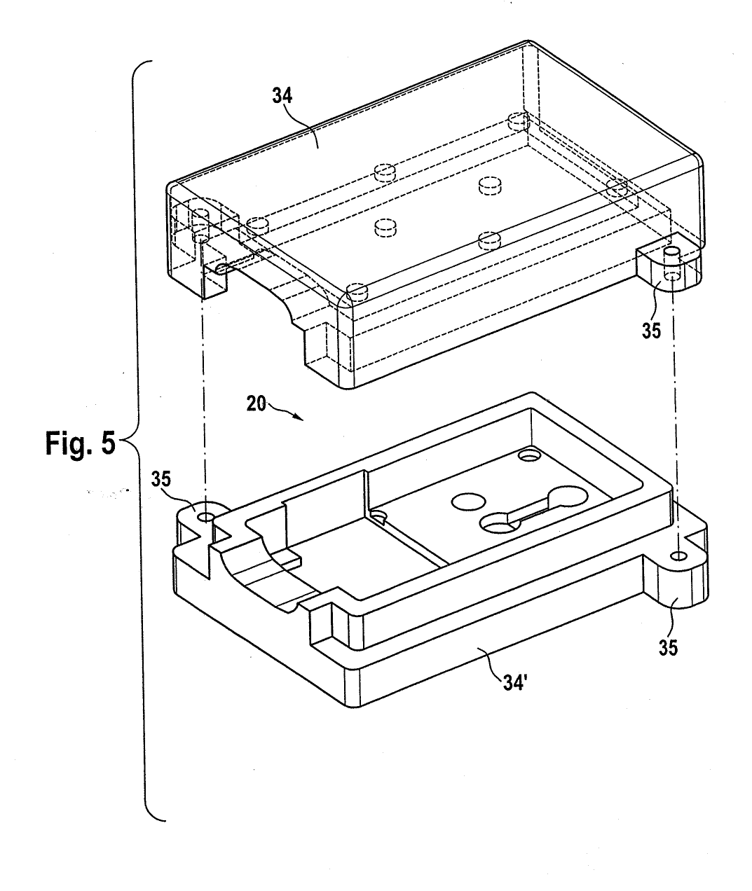

FIG. 5 shows a perspective illustration of external insulation comprising two half-shells for the continuous-flow heater shown in FIG. 4,

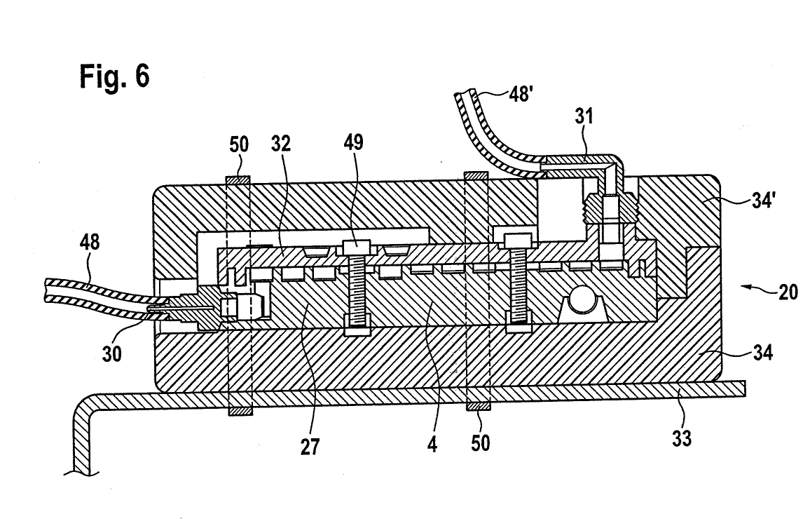

FIG. 6 shows a longitudinal section through the continuous-flow heater shown in FIG. 4 with external insulation,

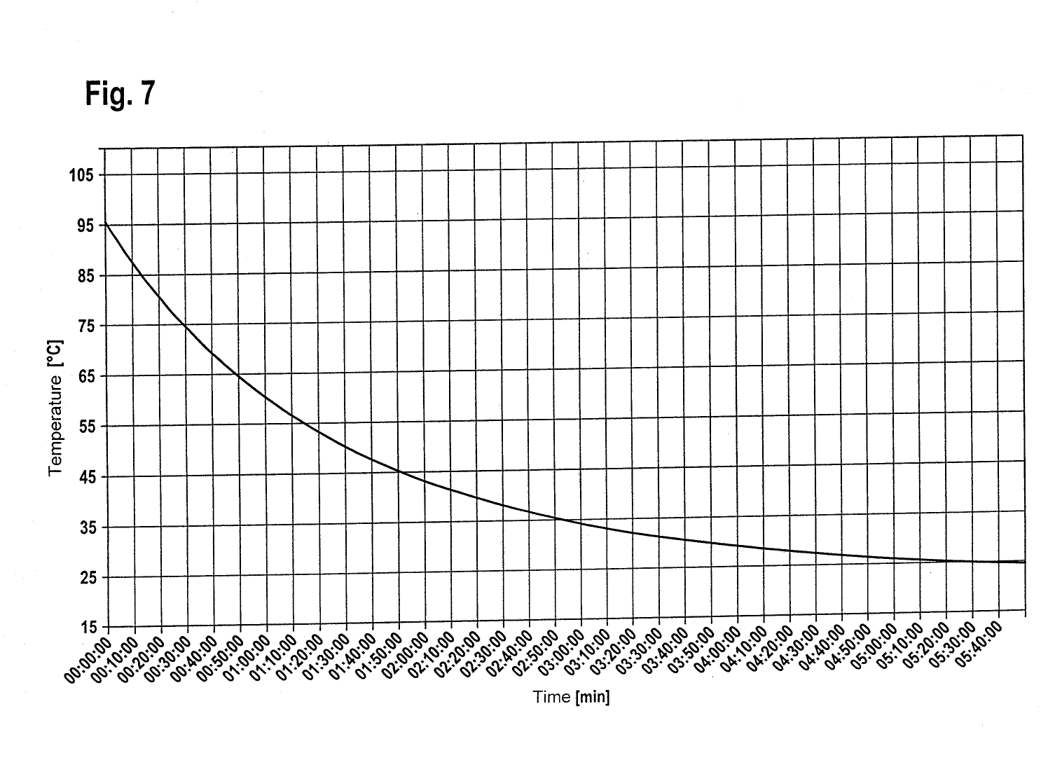

FIG. 7 shows a graph showing the cooling on a continuous-flow heater as a function of time,

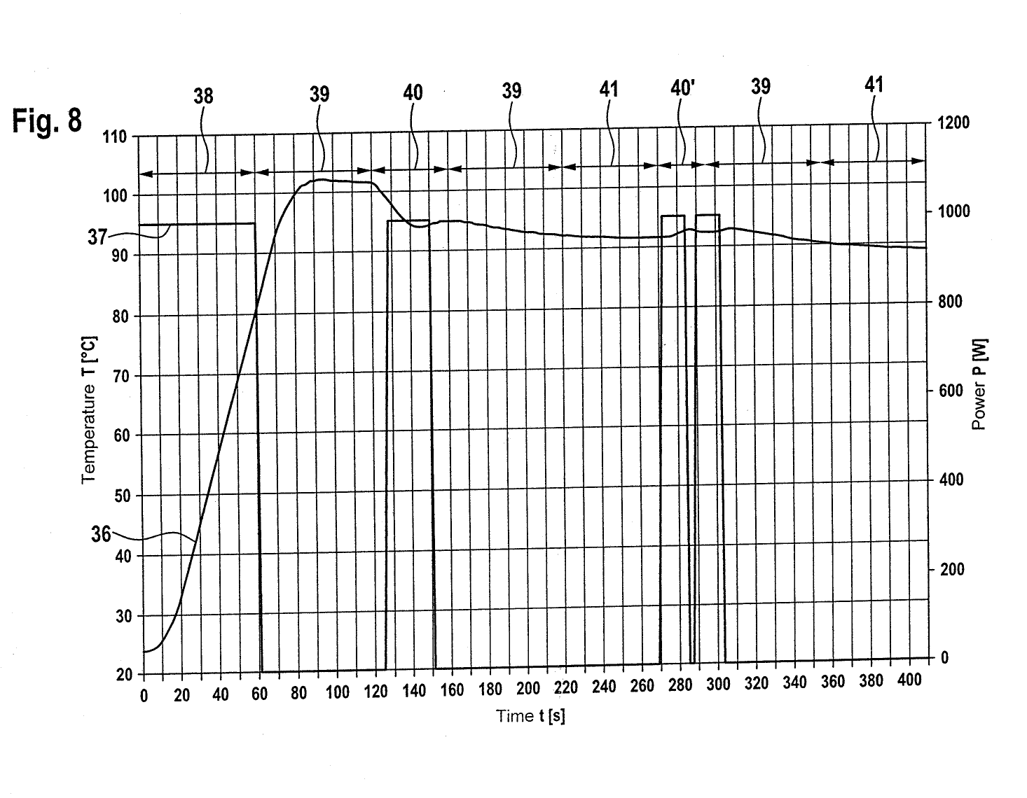

FIG. 8 shows a graph showing the temperature on the continuous-flow heater and showing the power draw of the latter as a function of time in various stages of operation, and

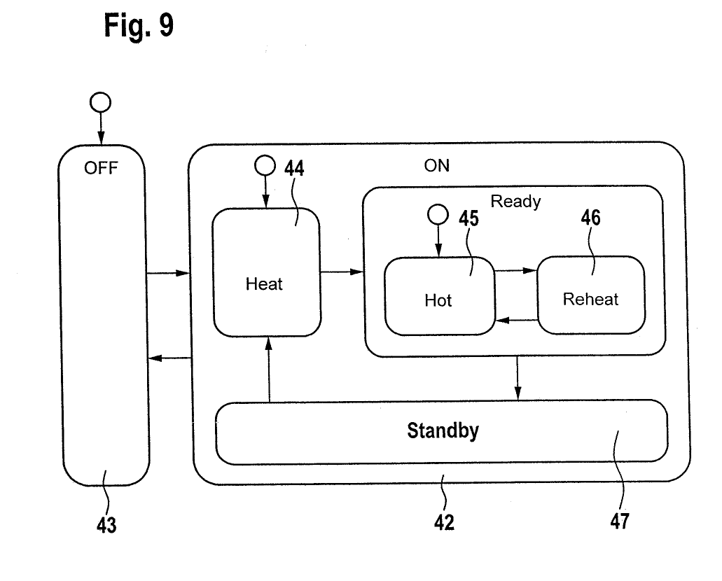

FIG. 9 shows a schematic illustration of the possible operating states of the apparatus.

The coffee machine shown in simplified form in FIG. 1 has a brewing chamber 1 which can hold a capsule 2 containing coffee in powder form. In this case, the brewing chamber comprises a capsule holder 16 and an injector head 17, which can be pressed against the capsule holder to form a seal. When the brewing chamber is completely closed, the capsule 2 can be penetrated, so that hot water can be passed through the capsule by the injector head 17. The coffee leaves the brewing chamber via an outlet 18, beneath which a coffee cup 19 can be positioned. The operating principle of such a brewing chamber is described in EP 1 721 553, for example.

The brewing water comes from a water tank 6, from which it can be supplied to a continuous-flow heater 4 by means of a pump 3. By way of example, the pump may be an electric vibration pump, typical of coffee machines, with a power draw of 50 watts and a maximum operating pressure of 20 bar, for example. Such pumps are supplied by Ulka S.p.A., Corso Cavour, 9, 27100 Pavia, Italy, under the name E4, for example. The use of alternative pump types such as diaphragm pumps etc. is naturally conceivable.

The quantity of water conveyed by the pump is ascertained using a flow sensor 7. In this way, the pump operation can be controlled such that different quantities are conveyed according to the desired type of coffee.

The continuous-flow heater 4, which is provided with external insulation 20, heats the water temperature to a value between 95° C. and 105° C., for example. The temperature of the water flowing from the continuous-flow heater 4 is ascertained using a temperature sensor 8. The flow sensor 7 and the temperature sensor 8 are both operatively connected to a control circuit 13, which takes the operating state of the apparatus as a basis for performing various control tasks.

The brewing chamber 1 is provided with an opening element 15, for example with a lever mechanism. An ejection switch 14 is operated by the opening element and is for its part operatively connected to the control circuit 13. Furthermore, the ejection switch prevents the pump 3 from being able to be operated when the brewing chamber 1 is open.

The coffee machine has further indicator and control elements. The illuminated switches 21, 22 and 23 can be used to start a brewing operation, where every single switch corresponds to a particular amount of liquid, for example. By way of example, the illuminated switch 24 can be used to initiate a rinsing operation, which involves a somewhat larger amount of water being passed through the closed, but empty, brewing chamber. It goes without saying that switches 21 to 24 could also be replaced by other switching elements, such as by a selector switch. By way of example, a switchless light emitting diode 25 can fulfill further indication and/or illumination purposes. Finally, the apparatus also has a further light emitting diode 26, for example a pulsed-operation light emitting diode, which indicates the standby mode.

The coffee machine is supplied with electrical power by the power supply system via a main switch 11. An electrostatic discharge protector 12 (ESD Protections) ensures that no components can be charged and that no electronic circuits are disturbed.

A fundamental element of the apparatus is the electronic switching module 5, which supplies the control circuit 13 with DC operating voltage and initiates and terminates the standby mode. By way of example, this is a standby supply module of BPS1 Series type from Bias Power LLC, Buffalo Grove, USA. Such a module has an extraordinarily low power draw of less than 30 mW for an output power of no more than 1 watt in standby mode. The manner of operation of such a module is described in WO 01/54260, for example.

The pump 3 and the continuous-flow heater 4 are supplied with power at 230 volts AC, for example, via the insulated switches 9 and 10. These are likewise operatively connected to the control circuit 13 and can be actuated by the latter.

After a predeterminable time of 60 seconds after a brewing operation has ended, for example, the switching module switches the apparatus to the standby mode. In this mode, not only are the switches 9 and 10 opened but also the sensors 7 and 8 and the light emitting diodes/switches 21 to 25 are decoupled from the operating voltage and are therefore no longer in action. Only the standby indicator 26 is supplied with power and signals that the main switch 11 is on and that the machine is merely in standby mode.

Further details relating to the continuous-flow heater can be seen in FIGS. 2 to 4, and further details relating to the external insulation thereof can be seen in FIGS. 5 and 6. The continuous-flow heater essentially comprises a cuboid basic element 27, for example comprising a metal which is a good conductor of heat, such as aluminum, copper or steel, in which a U-shaped heater 28 for electrical resistance heating is incorporated. One surface of the basic element 27 has a meandrous channel 29 arranged on it. This channel route attains a heating section of optimum length through which the liquid needs to pass in order to be heated. The top of the basic element 27 and hence also the channel 29 is sealed by means of a cover 32. The basic element and the cover are held together by screws 49 which penetrate the whole unit between the meandrous channel. The water enters the continuous-flow heater at room temperature at an entrance 30 and leaves it at an operating temperature of between 90° C. and 105° C., for example, at an exit 31. As can be seen from FIG. 4, the temperature sensor 8 may be mounted directly on the continuous-flow heater or may be incorporated therein.

As shown in FIG. 5, the external insulation 20 comprises two half-shells 34 and 34′ which can be assembled with a precise fit by means of interlocking wall sections. The internal contour of said half-shells matches the external contour of the continuous-flow heater 4 with a largely precise fit. The continuous-flow heater can therefore be embedded in the external insulation with virtually no play. The two half-shells 34 and 34′ are preferably connected exclusively by the precise fit, with latching cams, interlocking teeth, wedge faces with self-locking taper etc. also being conceivable. Alternatively or in addition, the connection can also be made with suitable connection means or clamping means which could be attached to the connecting lugs 35, for example. Alternatively, the two half-shells can also be held together by means of strapping, for example using a tensioning strap. In the present exemplary embodiment, the two half-shells have a wall thickness of approximately 15 to 22 mm, for example. The material is the aforementioned polypropylene foam Neopolen® from BASF.

FIG. 6 shows the continuous-flow heater 4 which is completely embedded in the external insulation 20 and which is in direct contact with the remainder of the apparatus merely by means of plastic tubes 48 and 48′. By contrast, mounting within the machine housing is effected using a mounting plate 33, for example, exclusively on the external insulation, without a direct heat bridge to the continuous-flow heater. By way of example, the external insulation could be fixed to the mounting plate 33 by means of cable ties 50 comprising plastic material. These are simply cut open and then replaced for maintenance work.

FIG. 7 shows how the external insulation with the desired heat-insulating values affects the cooling of the water temperature on the continuous-flow heater. Immediately at the start of the standby mode and at the end of a ready cycle, the water temperature is 95° C., for example. After 30 minutes, the temperature is still 75° C., and after 1 hour, it is still approximately 60° C. Even after around 2 hours, a temperature of, approximately 45° C. can still be expected, which means that the ready status can be restored within seconds following interruption of the standby mode. This is all the more so the case when the continuous-flow heater has a relatively high power draw of approximately 1000 watts.

FIG. 8 shows various operating states of the coffee machine as a function of time, the temperature curve 36 on the left-hand side indicating the temperature in degrees Celsius. On the right-hand side, the power curve 37 indicates the power draw in watts. After the coffee machine has been switched on, a heating phase 38 begins, during which the continuous-flow heater is heated at full power of 1000 watts. After approximately 60 seconds, the machine enters a ready mode 39, in which no further heat energy is supplied, but the temperature continues to rise slightly to a value of approximately 105° C. After a little more than 120 seconds, a first brewing operation 40 starts for normal coffee, during which the continuous-flow heater is again supplied with full power. When the brewing operation has terminated, the machine again enters a ready mode 39, which is superseded by the standby mode after 60 seconds, however. In this standby mode, light emitting diodes, sensors etc. which are not needed are also decoupled from the supply current. When a control element of the coffee machine is operated, it is in turn possible to perform two brewing operations 40′ for espresso in quick succession, for example, which in the present example are plotted on the time axis between 270 seconds and approximately 300 seconds. As a result of the continued high water temperature of above 90° C. on the continuous-flow heater, it is not necessary to accept any waiting times. Immediately after the conclusion of the last brewing operation, the machine enters the ready mode 39 again, which is superseded by the standby mode 41 again after 60 seconds, however. To maintain the 60-second ready mode, the second use of heating for the espresso brewing operation 40′ spans the end of the espresso brewing. As can be seen from the temperature curve 36, this reheating also results in a slight temperature rise again.

If the machine is not used for a relatively long time, the temperature curve 36 adopts the profile shown in FIG. 7, for example, in which case the next interaction with the machine may involve having to accept a waiting time of no more than approximately 60 seconds before the machine is ready.

The overall power draw of the machine at full load is approximately 1.05 kW, namely approximately 1 kW for the continuous-flow heater and approximately 50 W for the pump. Added to this is also approximately 0.6 W for the electronics during operation and for the remainder of the loads. In standby mode, the power draw is only 0.3 W or less, however.

FIG. 9 also shows the various possible operating states. The machine is always in one of the operating states shown, namely machine on 42 or machine off 43. Within the selected operating state, a distinction is drawn between heating 44, hot 45 or reheating 46. Added to this is the standby mode 47 as a whole. When the main switch (FIG. 1) is used to switch off, the operation of the machine is deactivated and the power consumption is reduced to 0. By contrast, when the main switch is switched on, the operation of the machine is activated and the continuous-flow heater starts to be heated 44. When the target temperature is reached, the machine is universally changed over to ready mode. While the actual temperature is within the tolerance limit, the machine remains in the hot ready mode 45. Only when the temperature on the continuous-flow heater drops below the tolerance limit is the reheating mode actuated. The transition from ready mode 45/46 to standby mode 47 is controlled by means of a timer when the user is not interacting with the machine. All the sensors, actuators and signaling elements are deactivated, with the exception of a signal lamp for standby mode, which is active on a pulsed basis, for example. The standby mode is left when the user next interacts. This may involve the user operating either a drinks dispense key, the rinse key or the capsule ejector. It would naturally also be conceivable to have other sensors which can be used to interrupt standby mode, such as voice recognition sensors, motion sensors, color-recognition sensors etc.

1-15. (canceled)

16. An apparatus for brewing a beverage,
having a brewing chamber (1) for holding a substance to be brewed or a portion pack (2) containing said substance,
having an electric pump (3) for routing a liquid through the brewing chamber,
having an electric continuous-flow heater (4) for heating the liquid,
and possibly having further electrical loads, sensors and/or control elements,
wherein, after a predeterminable time has elapsed after the end of a brewing operation or after the operation of a control element, the apparatus can be changed over by means of an electronic switching module (5) to a standby mode in which at least the continuous-flow heater and preferably the pump are switched off and do not consume electrical power.

17. The apparatus as claimed in claim 16, characterized in that not only the continuous-flow heater (4) but also further electrical loads such as sensors, lighting means and the like are included in the standby mode and can have their power consumption reduced or can be switched off by said standby mode.

18. The apparatus as claimed in claim 16, characterized in that it has a plurality of lighting means, particularly for indicating a state, which are able to be switched off by the switching module (5) with the exception of a single lighting means which is used for indicating the standby mode.

19. The apparatus as claimed in claim 16, characterized in that the standby mode can be terminated by operating a control element of the apparatus, wherein it is either possible to actuate a ready mode in which the continuous-flow heater is heated or to start a brewing operation immediately.

20. The apparatus as claimed in claim 16, characterized in that the power draw in standby mode is no more than 0.5 watt, preferably no more than 0.3 watt.

21. The apparatus as claimed in claim 16, characterized in that the continuous-flow heater (4) is provided with heat-insulating external insulation (20), the heat transfer coefficient of which is no more than 2 W/m²K, preferably no more than 1 to 1.5 W/m²K.

22. The apparatus as claimed in claim 16, characterized in that the continuous-flow heater (4) reaches a liquid temperature of at least 95° C. and in that it is provided with heat-insulating external insulation such that the cooling in standby mode after 2 hours is no more than 40° C., preferably no more than 50° C.

23. The apparatus as claimed in claim 21, characterized in that the external insulation (20) comprises a copolymer of propene and olefins (Expanded Polypropylene—EPP).

24. The apparatus as claimed in claim 21, characterized in that the continuous-flow heater (4) is of cuboid design and has a meandrous passage channel (29).

25. The apparatus as claimed in claim 21, characterized in that the external insulation (20) encompasses the continuous-flow heater (4) with a largely precise fit.

26. The apparatus as claimed in claim 25, characterized in that the external insulation (20) is formed by two half-shells (34, 34′) which preferably interlock with a precise fit and which are held together with or without additional clamping means.

27. The apparatus as claimed in claim 16, characterized in that the switching module (5) has been programmed by means of a timer such that after 30 seconds to 120 seconds, preferably after 60 seconds, since the termination of a brewing operation or since the last operation of a control element the standby mode can be switched on.

28. The apparatus as claimed in claim 16, characterized in that the brewing chamber (1) is intended to hold a capsule (2), wherein the capsule can be penetrated when the brewing chamber is closed, and in that an opening element (15) is provided for the purpose of opening and closing the brewing chamber or for the purpose of ejecting the capsule, wherein the operation of the opening element interrupts the standby mode.

29. The apparatus as claimed in claim 16, characterized in that it has a programmable control circuit which can be used to program operation-related parameters or which can be used to store operation-related parameters for diagnostic purposes.

30. The apparatus as claimed in claim 21, characterized in that the continuous-flow heater is supported and/or mounted on the external insulation within the apparatus in order to avoid heat bridges.
